(19) United States
(12) Patent Application Publication
(10) Pub. No.: US 2026/0148055 A1
(43) Pub. Date: May 28, 2026

(54) CONTRASTIVE FRAMEWORK FOR UNIFIED GENERATIVE AND DISCRIMINATIVE REPRESENTATION LEARNING

(71) Applicant: NVIDIA Corporation, Santa Clara, CA (US)

(72) Inventors: Micha LIVNE, Austin, TX (US); Michelle Lynn GILL, New York, NY (US)

(21) Appl. No.: 18/957,294

(22) Filed: Nov. 22, 2024

(51) Int. Cl. G06N 3/08; G06N 3/0455

(52) U.S. Cl. CPC G06N 3/08; G06N 3/0455

(57) ABSTRACT

In various examples, a technique for performing unified generative and discriminative learning includes converting, via execution of a machine learning model, a plurality of training data samples into a first plurality of latent representations. The technique also includes computing one or more losses based on the plurality of latent representations, wherein the loss(es) include a contrastive term that approximates an expected similarity between a latent representation of a training data sample and a second plurality of latent representations associated with a distribution of training data samples that includes the plurality of training data samples. The technique further includes updating one or more parameters of the machine learning model based on the one or more losses to generate a trained machine learning model.

### TECHNICAL FIELD

Embodiments of the present disclosure relate generally to machine learning and representation learning, and more specifically to a contrastive framework for unified generative and discriminative representation learning.

### BACKGROUND

Representation learning refers to techniques for training machine learning models to learn useful representations of raw data. For example, a machine learning model such as a deep neural network may be trained to convert images, text, video, audio, and/or other types of raw data into latent “embedded” representations in a lower-dimensional latent space. During the training process, the machine learning model may learn latent representations of the raw data that can be used to reconstruct the raw data, generate new data samples from the same distribution as the raw data, classify the raw data, cluster the raw data, infer properties and/or attributes of the raw data, and/or perform other tasks using the raw data.

It can be difficult for machine learning models to learn “informative” representations of raw data that are effective for different types of downstream tasks. For example, a Mutual Information Machine (MIM) model may include a probabilistic autoencoder that learns informative and clustered latent representations by minimizing the marginal entropy of the distribution of the latent representations. While this clustering allows latent representations for similar samples of raw data to be close to one another in the latent space, the latent representations may be distributed within the latent space in a way that is not conducive to unique identification of each latent representation within the latent space. Consequently, latent representations produced by the MIM model may be less suitable for discriminative downstream tasks that involve distinguishing between data samples than latent representations generated by other types of machine learning models.

Existing approaches for generating representations that can be used by discriminative downstream tasks involve using a contrastive learning technique to train a machine learning model that generates the representations. The contrastive learning technique includes a contrastive loss that encourages latent representations of similar data samples to be closer together in the latent space while pushing latent representations of dissimilar data samples farther apart in the latent space. As an illustrative example, an Information Noise-Contrastive Estimation (InfoNCE) loss is a common contrastive loss that is formulated as a B-way classification problem from a batch of size B. The InfoNCE loss is computed using measures of similarity between pairs of data samples in the batch. These pairs of data samples include (i) a positive pair that includes augmented versions of the same original data sample and (ii) negative pairs that include one of the data samples in the positive pair and remaining data samples in the batch. Training a machine learning model using the InfoNCE loss causes the machine learning model to increase the similarity between latent representations of the positive pair of data samples and decrease the similarity between latent representations of the remaining negative pairs of data samples.

However, conventional contrastive learning techniques are associated with a number of drawbacks. First, a meaningful augmentation of data samples in positive pairs is typically required for effective learning using the InfoNCE loss (or other types of contrastive loss), but it can be difficult to determine such a meaningful augmentation for certain types of data. For example, while images can be augmented using various types of modifications (e.g., cropping, flipping, rotating, translating, zooming, scaling, color transformations, adding noise, etc.), it can be difficult to augment other types of data (e.g., text) without affecting the semantic content of the data. Additionally, the selected augmentation(s) can introduce an inductive bias that does not capture all desired invariances within the data. Second, the effectiveness of the contrastive loss is sensitive to the selection of negative data samples and the batch size used to compute the contrastive loss.

As the foregoing illustrates, what is needed in the art are more effective techniques for learning representations of data.

### BRIEF DESCRIPTION OF DRAWINGS

FIG. 1 illustrates a block diagram of a computing system configured to implement one or more aspects of at least one embodiment;

FIG. 2 is a more detailed illustration of the training engine and execution engine of FIG. 1, according to at least one embodiment;

FIG. 3A illustrates an encoding factorization of a joint distribution associated with the machine learning model of FIG. 2, according to at least one embodiment;

FIG. 3B illustrates a decoding factorization of a joint distribution associated with the machine learning model of FIG. 2, according to at least one embodiment;

FIG. 4 illustrates how the machine learning model of FIG. 2 is used to generate a set of informative embeddings for an example data sample, according to at least one embodiment;

FIG. 5 illustrates a flow diagram of a method for performing generative and discriminative representation learning, according to at least one embodiment;

FIG. 6 illustrates a flow diagram of a method for generating an embedding of a data sample, according to at least one embodiment;

FIG. 7A illustrates inference and/or training logic, according to at least one embodiment;

FIG. 7B illustrates inference and/or training logic, according to at least one embodiment; and

FIG. 8 illustrates training and deployment of a neural network, according to at least one embodiment.

### DETAILED DESCRIPTION

As discussed herein, it can be difficult for machine learning models to learn informative representations of raw data that are effective for various types of downstream tasks. More specifically, existing contrastive learning approaches use augmented data to generate representations that can be used in discriminative downstream tasks. However, certain types of data do not have well-defined augmentations, and the generation of augmented data for positive pairs can introduce an inductive bias that fails to capture all desired invariances within the data. Conventional contrastive learning approaches may also, or instead, involve computing measures of similarity between positive and negative pairs of data samples in a batch of training data. Consequently, the effectiveness of a given contrastive learning framework may be sensitive to the selection of negative data samples and/or the batch size used to compute a corresponding contrastive loss.

To address the above limitations, the disclosed techniques extend a Mutual Information Machine (MIM) model and/or another type of latent variable model using a contrastive learning component that distinguishes between each data sample and all other data samples from the same distribution. The contrastive learning component includes an additional random variable that represents the relationship between a data sample and a latent representation. The random variable is set to 1 when the latent representation corresponds to the data sample and to 0 otherwise. The contrastive learning component also uses Markov Chain Monte Carlo (MCMC) sampling to approximate the expected similarity between a given data sample and other data samples in the distribution, which decouples the similarity estimation associated with contrastive learning from the batch size used to train the latent variable model. The additional random variable is incorporated into encoding and decoding factorizations of a joint distribution over data and latent representations that are learned by the encoder and decoder of the latent variable model, respectively. The discriminator distributions for the encoding and decoding factorizations are defined as Bernoulli distributions. Each Bernoulli distribution includes a parameter that approximates the probability that the random variable is set to 1 using a similarity measure that is computed between pairs of latent representations.

During training (updating) of the latent variable model, parameters of the latent variable model are updated in a way that reduces a combination of a MIM loss (or another type of loss associated with the latent variable model) and a contrastive term corresponding to the contrastive learning component. The MIM loss clusters latent representations of similar data samples, and the contrastive term encourages dissimilar data samples to be farther apart from one another with respect to an origin in the latent space.

The disclosed techniques also generate informative embeddings from a MIM model and/or another type of encoder-decoder model that learns a distribution over a set of outputs. An encoder in the encoder-decoder model is used to convert a given data sample into a latent representation, and the latent representation is inputted into a decoder in the encoder-decoder model. The informative embeddings are extracted as hidden outputs from one or more hidden layers of the decoder (e.g., before the hidden outputs are converted into parameters of the decoded output distribution) and can be used for various downstream tasks. When the encoder-decoder model generates autoregressive distributions, teacher forcing can be used to input both the data sample and the latent representation into the decoder. The decoder then generates, in parallel, multiple sets of hidden outputs from the inputted data sample and latent representation, where each set of hidden outputs corresponds to a different position in a sequence associated the data sample and is conditioned on preceding positions within the sequence. The multiple sets of hidden outputs can then be averaged or otherwise aggregated into a fixed-size representation.

One advantage of the disclosed techniques relative to prior approaches is the ability to generate informative representations of data that are effective for various downstream tasks, including (but not limited to) generative downstream tasks and discriminative downstream tasks. Consequently, the disclosed techniques may improve the performance of the downstream tasks relative to MIM models (or other type of latent variable and/or encoder-decoder models) that do not optimize for unique identification of individual latent representations within a latent space. Another advantage of the disclosed techniques is the ability to incorporate contrastive learning into a latent variable model without performing data augmentation and/or selecting negative data samples and batch sizes. The disclosed techniques may thus simplify training of the latent variable model and/or reduce inductive bias over conventional contrastive learning techniques that use augmented data and/or batches of positive and negative data samples to train machine learning models.

The above examples are not in any way intended to be limiting. As persons skilled in the art will appreciate, as a general matter, the techniques for automatically generating dialogue flows from unlabeled conversation data can be implemented in any suitable application.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), small language models (SLMs), vision language models (VLMs), and/or multi-modal language models that may process text, audio, and/or image data, systems for performing light transport simulation, systems for performing collaborative content creation for 3D assets (e.g., systems or platforms that use universal scene descriptor (USD) data, such as OpenUSD), systems implemented at least partially using cloud computing resources, systems for performing generative AI operations, and/or other types of systems.

### System Overview

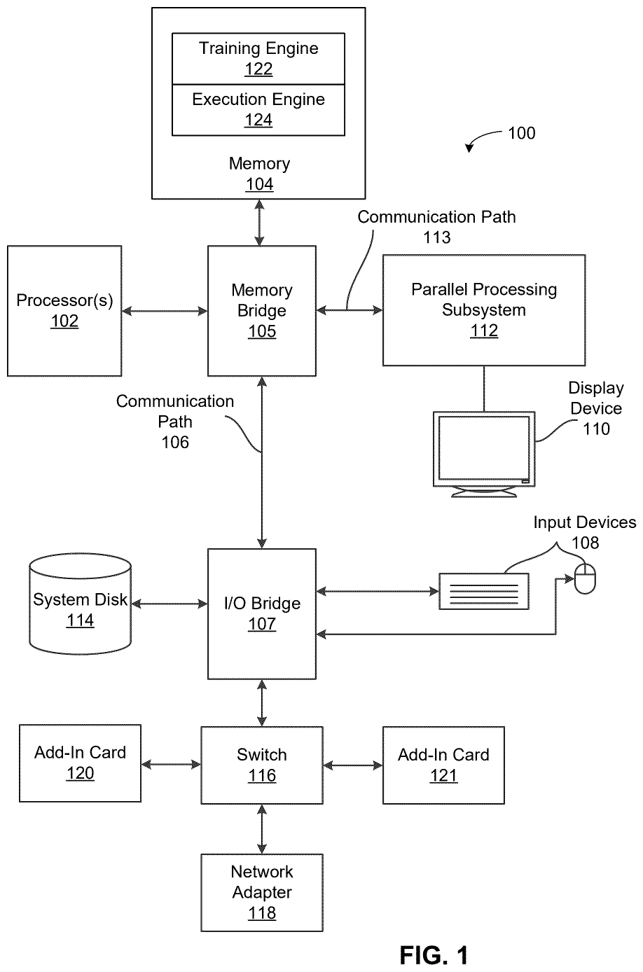

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include instructions implementing a training engine 122 and an execution engine 124, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs, pixel processing engines (PPEs), and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a Peripheral Component Interconnect Express (PCIe) link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Further, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

In some embodiments, training engine 122 and execution engine 124 include functionality to train and execute a machine learning model to generate latent representations of input data samples that can be used for a variety of downstream tasks. More specifically, training engine 122 trains the machine learning model using a contrastive learning component that distinguishes between each data sample and all other data samples from the same distribution. This contrastive learning component allows the latent representations to be uniquely identifiable within a corresponding latent space, thereby improving the performance of discriminative downstream tasks using the latent representations. Execution engine 124 uses one or more components of the trained machine learning model to generate informative embeddings that can be used to supplement and/or replace the latent representations of the corresponding data samples. These informative embeddings may include values and/or aggregations of hidden outputs generated by a decoder in the trained machine learning model. Training engine 122 and execution engine 124 are described in further detail below.

### Unified Generative and Discriminative Representation Learning

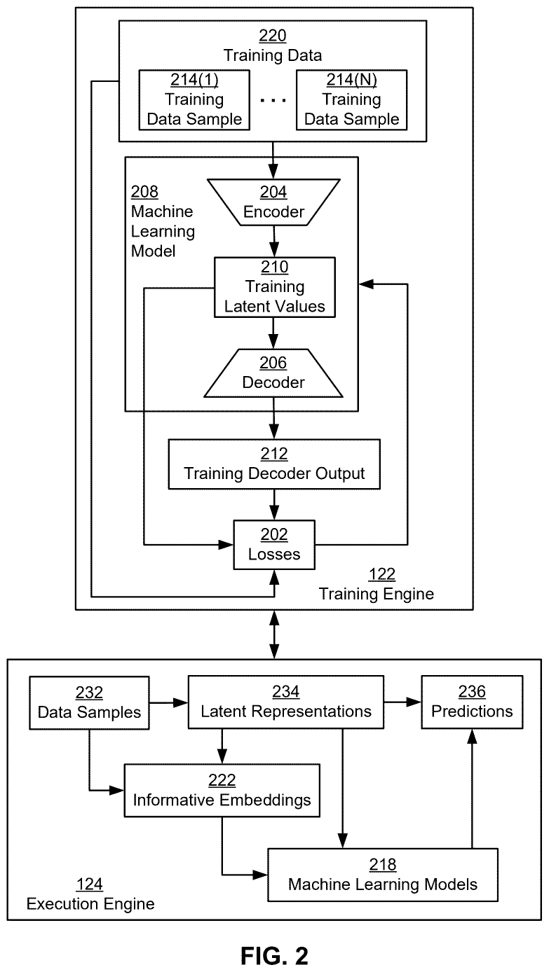

FIG. 2 is a more detailed illustration of training engine 122 and execution engine 124 of FIG. 1, according to at least one embodiment. As discussed herein, training engine 122 and execution engine 124 are configured to train (update) and execute a machine learning model 208 to generate latent representations 234 and/or informative embeddings 222 of input data samples 232 that can be used for a variety of downstream tasks. Each of these components is described in further detail below.

Training engine 122 trains machine learning model 208 using training data 220 that includes a number of training data samples 214(1)-214(N) (each of which is referred to individually herein as training data sample 214). Training data samples 214 are associated with one or more types of data for which latent representations 234 are to be generated. For example, training data samples 214 may include (but are not limited to) images, text, three-dimensional (3D) data (e.g., point clouds, meshes, universal scene descriptor (USD) data, etc.), representations of molecules (e.g., in the form of strings, sequences of characters, graphs, images, 3D representations, etc.), audio, video, and/or other types of data to be characterized using latent representations 234.

During training of machine learning model 208, training engine 122 uses an encoder 204 in machine learning model 208 to convert a given training data sample 214 into a corresponding set of training latent values 210. Training engine 122 also uses a decoder 206 to convert a given set of training latent values 210 generated by encoder 204 into a corresponding set of training decoder output 212. For example, encoder 204 and/or decoder 206 may correspond to feedforward neural networks, convolutional neural networks (CNNs), recurrent neural networks (RNNs), residual neural networks, long short-term memory networks (LSTMs), graph neural networks, transformer neural networks, and/or other types of neural networks. Encoder 204 may transform an inputted training data sample 214 into a vector (or another representation) of training latent values 210 in a lower-dimensional latent space. Decoder 206 may transform the training latent values 210 into training decoder output 212 that corresponds to a decoding distribution (i.e., reconstruction) associated with the inputted training data sample 214. Encoder 204 and decoder 206 may thus form a latent variable machine learning model 208 (e.g., generative adversarial network (GAN), variational autoencoders (VAE), diffusion model, etc.) that can be used to learn training latent values 210 that reflect various properties of the corresponding training data samples 214.

After encoder 204 and decoder 206 are used to generate one or more sets of training latent values 210 and/or training decoder output 212 from one or more training data samples 214, training engine 122 computes one or more losses 202 using training latent values 210, training decoder output 212, and/or training data samples 214. Training engine 122 then uses a training technique (e.g., gradient descent and backpropagation) to iteratively update parameters of encoder 204 and decoder 206 in a way that reduces losses 202.

In some embodiments, machine learning model 208 corresponds to a Mutual Information Machine (MIM) model that maximizes mutual information between training data samples 214 and the corresponding training latent values 210 while maintaining symmetry between encoder 204 and decoder 206. The MIM model may include a probabilistic autoencoder that minimizes the marginal entropy of the distribution over training latent values 210, which results in latent representations 234 that are clustered in Euclidean space for similar data samples 232. More specifically, the similarity between data samples 232 may be defined by the decoding distribution associated with decoder 206, which leads to a local structure around each latent representation (i.e., similar data samples 232 correspond to latent representations 234 that are near one another in the Euclidean space).

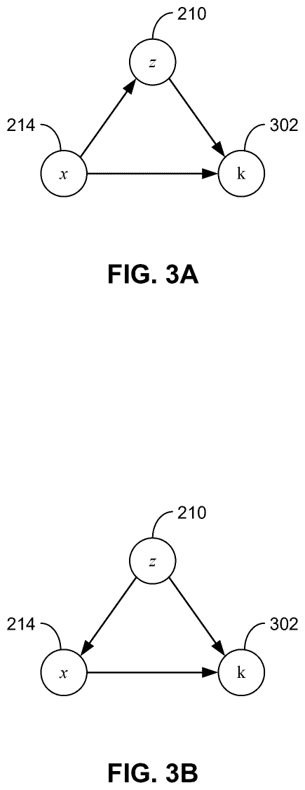

In one or more embodiments, losses 202 include a MIM objective that encourages latent representations 234 of similar samples to be close to one another in Euclidean space (as described above), as well as a contrastive term that introduces a global discriminative structure to the latent space. The contrastive term is associated with a random variable that represents the relationship between a data sample and a latent representation. This random variable is incorporated into factorizations of the joint distribution over training data samples 214 and training latent values 210 that are learned by encoder 204 and decoder 206, as described in further detail with respect to FIGS. 3A-3B.

FIG. 3A illustrates an encoding factorization of a joint distribution associated with machine learning model 208 of FIG. 2, according to at least one embodiment. As shown in FIG. 3A, the encoding factorization includes a component denoted by x that is associated with training data samples 214, a component denoted by denoted by z that is associated with training latent values 210, and a random variable 302 denoted by k. Arrows between x, z, and k in the encoding factorization indicate relationships between training data samples 214, training latent values 210, and random variable 302.

In some embodiments, the encoding factorization includes a parameterized prior q_{θ}(x) that approximates a distribution of training data samples 214 [symbol] (x). Arrows from x and z to k represent a contrastive learning component q_{θ}(k|x,z) in the encoding factorization that incorporates training data samples 214 and training latent values 210 into a distribution associated with random variable 302. An arrow from x to z represents a parameterized posterior q_{θ}(z|x) in the encoding factorization that approximates the distribution over possible values of latent values z for a given data sample x. The parameterized prior, contrastive learning component, and parameterized posterior of the encoding factorization are learned by encoder 204 during training of machine learning model 208.

FIG. 3B illustrates a decoding factorization of a joint distribution associated with machine learning model 208 of FIG. 2, according to at least one embodiment. As shown in FIG. 3B, the decoding factorization also includes a component denoted by x that is associated with training data samples 214, a component denoted by denoted by z that is associated with training latent values 210, and random variable 302 denoted by k. Arrows between x, z, and k in the decoding factorization indicate relationships between training data samples 214, training latent values 210, and random variable 302.

In particular, the decoding factorization includes a parameterized prior p_{θ}(z) that approximates the distribution of training latent values 210 [symbol] (z). Arrows from x and z to k represent a contrastive learning component by p_{θ}(k|x,z) in the decoding factorization that incorporates training data samples 214 and training latent values 210 into a distribution associated with random variable 302. An arrow from z to x represents a parameterized likelihood p_{θ}(x|z) in the decoding factorization that approximates the likelihood distribution over possible data samples for a given set of latent values. The parameterized prior, contrastive learning component, and parameterized likelihood of the decoding factorization are learned by decoder 206 during training of machine learning model 208.

In one or more embodiments, the encoding factorization of FIG. 3A and decoding factorization of FIG. 3B are defined using the following:

$${q}_{θ} ( x , z , k ) = {q}_{θ} ( k \vert x , z ) {q}_{θ} ( z \vert x ) {q}_{θ} ( x ) \qquad ( 1 )$$

$${p}_{θ} ( x , z , k ) = {p}_{θ} ( k \vert x , z ) {p}_{θ} ( x \vert z ) {p}_{θ} ( z ) \qquad ( 2 )$$

In the above equations, q₀(x,z,k) denotes the encoding factorization and is computed as a product of the contrastive learning component q_{θ}(k|x,z), parameterized posterior q_{θ}(z|x), and parameterized prior q_{θ}(x). Further, p_{θ}(x,z,k) denotes the decoding factorization and is computed as a product of the contrastive learning component p_{θ}(k|x,z), parameterized likelihood p_{θ}(x|z), and parameterized prior p_{θ}(z).

Additionally, zᵢ may be defined as the latent representation of data sample xᵢ. Given xᵢ, the latent representation is sampled using the parameterized posterior (i.e., zᵢ˜q_{θ}(z|xᵢ)). Given zᵢ, the data sample is sampled using the parameterized likelihood (i.e., xᵢ˜p_{θ}(x|zᵢ)). Further, random variable 302 k is a binary variable that represents the relationship between a data sample x and a latent representation z. Specifically, for sample i, kᵢ=1 if x=xᵢ and z=zᵢ (as defined above), and kᵢ=0 otherwise.

In one or more embodiments, the prediction of random variable 302 k by machine learning model 208 encourages dissimilar samples to be more distinct in the latent space (e.g., as defined by a similarity function). More specifically, the MIM model (as represented by the prior, posterior, and likelihood components) naturally clusters similar latent codes by minimizing Euclidean distances in latent space for similar data samples. By introducing a direction-based similarity function, dissimilar samples can be encouraged to be farther apart in terms of their direction relative to the origin with minimal impact on the clustering properties of the model, thereby leading to a more discriminative latent space.

In some embodiments, the discriminator distributions for the encoding and decoding factorizations over k are defined as:

$${q}_{θ} ( k \vert z = {z}_{i} , x ) = {p}_{θ} ( k \vert z = {z}_{i} , x ) = Bernoulli ( k ; {p}_{k = 1} ) where \qquad ( 3 )$$

$${p}_{k = 1} = \frac{sim ( {z}_{i} , {z}_{i} )}{sim ( {z}_{i} , {z}_{i} ) + {𝔼}_{{x}^{′} \sim 𝒫 ( x \vert x \neq {x}_{i} ) , {z}^{′} \sim {q}_{θ} ( z \vert {x}^{′} )} [ sim ( {z}_{i} , {z}^{′} ) ]} \approx \frac{sim ( {z}_{i} , {z}_{i} )}{sim ( {z}_{i} , {z}_{i} ) + \frac{1}{B} {\sum }_{{j = 1}_{j \neq i}}^{B} sim ( {z}_{i} , {z}_{j} )} \qquad ( 4 )$$

In Equation 4, sim(⋅,⋅) is a similarity function between two sets of latent values in the latent space. For example, a cosine similarity may be used as the similarity function:

$$s i m ( {z}_{i} , {z}_{j} ) = exp ( \frac{1}{τ} \frac{{z}_{i}^{T} \cdot {z}_{j}}{‖ {z}_{i} ‖ ‖ {z}_{j} ‖} ) \qquad ( 5 )$$

In the above equation, τ is a temperature parameter that controls the sharpness of the distribution, and the exponent ensures that the similarity is non-negative.

The encoding and decoding factorizations above can be learned without relying on batch size for generating negative examples, which reduces sensitivity to batch size as the number of data samples increases. Additionally, the sampling process inherently insures that k=1, such that machine learning model 208 is not trained with samples where k=0. Further, by incorporating an expectation (i.e., as opposed to a B-way classification), the expected similarity with other data samples can be efficiently approximated using MCMC sampling. Unlike traditional contrastive learning, this formulation also does not require data augmentation, since clustering is achieved using the MIM objective.

In some embodiments, machine learning model 208 is trained using a MIM objective that is applied to the extended graphical model corresponding to the encoding and decoding factorizations:

$${ℳ}_{θ} ( x , z , k ) = \frac{1}{2} ( {p}_{θ} ( k \vert z , x ) {p}_{θ} ( x \vert z ) {q}_{θ} ( z ) + {q}_{θ} ( k \vert z , x ) {q}_{θ} ( z \vert x ) {p}_{θ} ( x ) ) \qquad ( 6 )$$

Specifically, MIM is defined over a mixture model in Equation 6, with a sampling distribution [symbol] (x,z,k) given by:

$${ℳ}_{𝒮} ( x , z , k ) = \frac{1}{2} ( {p}_{θ} ( k \vert z , x ) {p}_{θ} ( x \vert z ) 𝒫 ( z ) + {q}_{θ} ( k \vert z , x ) {q}_{θ} ( z \vert x ) 𝒫 ( x ) ) \qquad ( 7 )$$

In Equations 6 and 7, the discriminator distributions over k are introduced.

The learning process for MIM involves minimizing the following upper bound on the joint entropy of training data samples 214, training latent values 210, and random variable 302 under the mixture distribution [symbol] :

$${ℒ}_{MIM} ( θ ) = \frac{1}{2} ( CE ( {ℳ}_{𝒮} ( x , z , k ) , {q}_{θ} ( x , z , k ) ) + CE ( {ℳ}_{𝒮} ( x , z , k ) , {p}_{θ} ( x , z , k ) ) ) \geq {H}_{{ℳ}_{𝒮}} ( x , k ) + {H}_{{ℳ}_{𝒮}} ( z ) - {I}_{{ℳ}_{𝒮}} ( x , k ; z ) \qquad ( 8 )$$

In the above equation, CE denotes cross entropy, H represents entropy, I denotes mutual information, k is grouped with x, and k=1 for all data samples. Since the contrastive probability is formulated as a fixed mapping of training latent values 210 (i.e., without any learnable parameters), the learning process avoids learning trivial solutions where p_{θ}(k|z,x) and q_{θ}(k|z,x) always output a probability of 1.

The upper bound aims to reduce the entropy of the mixture distribution [symbol] , which is the sum of the joint entropy over x and k, the entropy of z, and the negative mutual information between (x,k) and z. Minimizing this upper bound results in (i) consistency of encoder 204 and decoder 206 in learning encoding and decoding distributions that define the same joint distribution, (ii) high mutual information under [symbol] between the joint distribution of training data samples 214 and random variable 302 and training latent values 210, and (iii) clustered latent codes with low marginal entropy.

The inclusion of random variable 302 k in Equation 8 allows the MIM model to distinguish between matching and non-matching pairs of training data samples 214 and training latent values 210, thereby incorporating contrastive learning into the MIM model without requiring augmentation of training data samples. The use of random variable 302 with MCMC sampling to approximate the expected similarity with other data samples from the same distribution [symbol] (x) additionally reduces the sensitivity of the MIM model to batch size. Further, the use of random variable 302 in defining the discriminator distributions for the encoding and decoding factorizations allows encoder 204 and decoder 206 to learn a locally clustered latent space with a global discriminative structure that is conducive to both generative and discriminative downstream tasks.

A corresponding loss for an asymmetric version of MIM (where the sampling distribution includes only the encoding distribution q_{θ}(k|z,x)q_{θ}(z|x) [symbol] (x)) includes the following:

$${ℒ}_{A - MIM} ( θ ) = \frac{1}{2} {𝔼}_{x \sim 𝒫 ( x ) , z \sim {q}_{θ} ( Z \vert X ) , k = 1} [ \begin{matrix}log {p}_{θ} ( k \vert z , x ) + log {p}_{θ} ( x \vert z ) + log 𝒫 ( z ) \\ + \\ log {q}_{θ} ( k \vert z , x ) + log {q}_{θ} ( z \vert x ) + log {q}_{θ} ( x )\end{matrix} ] \qquad ( 9 )$$

In the above equation, the expectation of z is taken over samples z˜q_{θ}(z|x), [symbol] (x) is the data distribution (e.g., a dataset of training data samples 214), and [symbol] (z) is a prior distribution over training latent values 210.

In one or more embodiments, training engine 122 trains machine learning model 208 using the following steps:

Require: Samples from dataset [symbol] (x)

| | |
|---|---|
| 1: | while not converged do |
| 2: | σ~ [symbol] (0, I) |
| 3: | $D ← {\{ {x}_{j} , {z}_{j} ∼ {q}_{θ} ( z \vert x , σ ) 𝒫 ( x ) \}}_{j = 1}^{N}$ |
| 4: | ${{ℒ}^{`}}_{A - MIM} ( θ ; D ) = - \frac{1}{N} {\sum }_{i = 1}^{N} ( log {p}_{θ} ( {x}_{i} \vert {z}_{i} ) + D ( {x}_{i} , {z}_{i} ) + \frac{1}{2} ( log {q}_{θ} ( {z}_{i} \vert {x}_{i} , σ ) + log 𝒫 ( {z}_{i} ) )$ |
| 5: | Δθ ∝ −∇_{θ} [symbol] _{A-MIM} (θ; D) |
| 6: | end while |

More specifically, training engine 122 uses a training loop to train machine learning model 208. During each iteration of the training loop, training engine 122 samples a value σ from a uniform distribution between 0 and 1 that is inclusive of 1 and exclusive of 0. Next, training engine 122 samples N training data samples 214 xⱼ from a dataset [symbol] (x) of training data 220. Training engine 122 also uses a as the standard deviation of the posterior q_{θ}(z|x,σ)≡ [symbol] (z|μ_{θ}(x,σ),σ) from which zⱼ is sampled. The sampling using a causes machine learning model 208 to accommodate different levels of uncertainty and learn a dense latent space that supports sampling with little to no “holes.”

Training engine 122 then computes losses 202 [symbol] _{A-MIM}(θ;D) as an average over the N training data samples 214. These losses 202 are computed using four terms. A first term of log p_{θ}(xᵢ|zᵢ) corresponds to a reconstruction loss that represents the log-likelihood of reconstructing a given training data sample 214 xᵢ(e.g., in the form of training decoder output 212) given a corresponding set of training latent values 210 zᵢ. A second term of D(xᵢ,zᵢ) represents a discriminator for the contrastive objective term, which can be defined as a Bernoulli distribution with the approximated parameter pₖ₌₁:

$$D ( {x}_{i} , {z}_{i} ) ≡ Bernoulli ( k = 1 ; {p}_{k = 1} ) = \frac{sim ( {z}_{i} , {z}_{i} )}{sim ( {z}_{i} , {z}_{i} ) + \frac{1}{B} {\sum }_{{j = 1}_{j \neq i}}^{B} sim ( {z}_{i} , {z}_{j} )} \qquad ( 10 )$$

A third term of log q_{θ}(zᵢ|xᵢ,σ) corresponds to a consistency loss that encourages consistency between the encoding of training data samples 214 into training latent values 210 by encoder 204 and decoding of training latent values 210 into training decoder output 212 by decoder 206. A fourth term of log [symbol] (zᵢ) corresponds to a regularization loss that regularizes training latent values 210 to follow a chosen prior distribution (e.g., an isotropic Gaussian distribution). The sum of the third and fourth terms is normalized by a factor of ½ to ensure that these terms are equally weighted in losses 202.

Training engine 122 then computes a gradient of losses 202 using the reparameterization trick, which expresses training latent values 210 as a deterministic function of a sampled auxiliary variable and/or training data samples 214. Training engine 122 also updates parameters θ of machine learning model 208 in a way that is proportional to the negative gradient of losses 202, thereby reducing losses 202. Training engine 122 performs additional iterations of the training loop until the parameters of machine learning model 208 converge and/or another condition is met.

Returning to the discussion of FIG. 2, execution engine 124 uses the trained machine learning model 208 to convert additional data samples 232 (e.g., data samples 232 that are not included in training data 220) into corresponding latent representations 234. More specifically, execution engine 124 uses the trained encoder 204 to convert data samples 232 into corresponding latent representations 234 in the latent space that is learned based on losses 202. Execution engine 124 also inputs latent representations 234 into one or more machine learning models 218 and uses machine learning models 218 to generate predictions 236 related to the corresponding data samples 232.

For example, execution engine 124 may use the trained encoder 204 to convert one or more data samples 232 (e.g., images, text, audio, video, molecules, 3D data, etc.) into corresponding latent representations 234. Execution engine 124 may perturb the generated latent representations 234 (e.g., by adding random Gaussian noise), traverse the latent space based on the generated latent representations 234, and/or interpolate between or among the generated latent representations 234 to generate one or more new latent representations 234. Execution engine 124 may also, or instead, condition the generation of one or more new latent representations 234 on a text prompt, one or more data samples 232, a noise sample, and/or other input. Execution engine 124 may then use decoder 206 to convert the new latent representations 234 into a new set of data samples that differ from training data samples 214 and/or data samples 232 inputted into encoder 204.

In another example, execution engine 124 may use the trained encoder 204 to convert one or more data samples 232 into corresponding latent representations 234. Execution engine 124 may input these latent representations 234 into one or more machine learning models 218 that are separate from encoder 204 and decoder 206. Each machine learning model may generate, for a given inputted latent representation, one or more corresponding predictions 236 associated with the corresponding data sample. These predictions 236 may include (but are not limited to) one or more classes to which the data sample belongs (e.g., a type of object depicted in an image corresponding to the data sample, a semantic segmentation of an image corresponding to the data sample, a type of molecule or drug corresponding to the data sample, a sentiment and/or topic associated with a text-based data sample, etc.), a property and/or attribute of the data samples (e.g., a score that represents a toxicity and/or level of toxicity of a molecule corresponding to the data sample, a similarity between the data sample and a different data sample, an efficacy and/or potency associated with a drug corresponding to the data sample, etc.), and/or other information that can be used to characterize and/or describe the data sample.

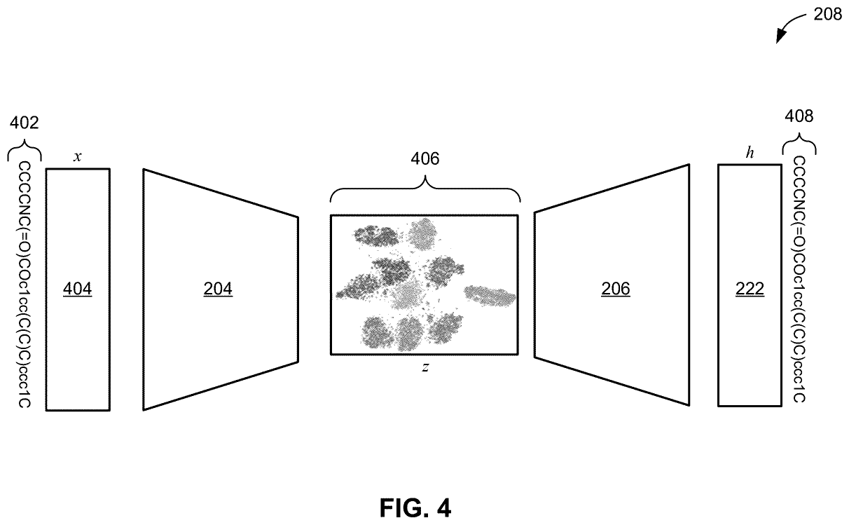

In one or more embodiments, execution engine 126 uses the trained machine learning model 208 to convert data samples 232 and/or corresponding latent representations 234 into informative embeddings 222. These informative embeddings 222 may be obtained as hidden outputs from one or more layers of the trained decoder 206, as described in further detail below with respect to FIG. 4. Informative embeddings 222 may then be inputted into machine learning models 218, in lieu of or in addition to latent representations 234 outputted by the trained encoder 204 from the corresponding data samples 232. In response to the inputted informative embeddings 222, machine learning models 218 may generate predictions 236 of classes, attributes, properties, scores, new data samples, and/or other output related to the corresponding data samples 232.

FIG. 4 illustrates how machine learning model 208 of FIG. 2 is used to generate a set of informative embeddings 222 for an example data sample 402, according to at least one embodiment. As shown in FIG. 4, data sample 402 corresponds to a Simplified Molecular Input Line Entry System (SMILES) string (i.e., “CCCCNC(=O)COc1cc(C(C)C)ccc1C”) representing a molecule. Each character in the string is converted into an encoded vector representation (e.g., by one or more embedding layers) to form an N×D input 404 denoted by x, where N is the length of the string and D is the embedding dimension associated with the encoded vector representation.

Input 404 is converted by encoder 204 into a latent representation 406 denoted by z. For example, encoder 204 may include a perceiver neural network (or another type of machine learning model that is capable of processing variable-sized input 404) that was trained using a MIM objective augmented with a contrastive term, as discussed above. Consequently, latent representation 406 may reside in a locally clustered latent space with a global discriminative structure that is conducive to both generative and discriminative downstream tasks.

Decoder 206 converts latent representation 406 into a set of informative embeddings 222 for data sample 402. For example, decoder may include a transformer neural network (or another type of machine learning model that is capable of processing variable-sized input 404) that was previously trained using a MIM objective augmented with a contrastive term, as discussed above. Consequently, decoder 206 may be capable of decoding latent representation 406 into decoder output 408 that corresponds to a reconstruction of data sample 402.

In one or more embodiments, informative embeddings 222 are extracted as hidden outputs h generated by one or more hidden layers of decoder 206 that precede a final decoder output 408. For example, informative embeddings 222 may correspond to an N×D matrix of hidden outputs generated by the last hidden layer in a transformer neural network corresponding to decoder 206. Each row of hidden outputs may be mapped to parameters of a decoded output distribution (i.e., p_{θ}(x|z)=f_{θ}(h)). A corresponding token of decoder output 408 may then be generated as the token with the highest probability in the decoded output distribution and/or by sampling from the decoded output distribution.

Because h encodes the distribution over the sequence of outputs associated with data sample 402, informative embeddings 222 may correspond to a more comprehensive latent representation 406 that has been augmented or “enriched” with additional contextual information from decoder 206. Consequently, informative embeddings 222 may be used to improve the performance of machine learning models that generate predictions of classes, attributes, scores, new data samples, reconstructions of data sample 402, and/or other generative and/or discriminative output associated with data sample 402.

When decoder 206 does not generate autoregressive distributions, hidden outputs of the last hidden layer of decoder 206 may be obtained as informative embeddings 222 (e.g., after latent representation 406 is inputted into decoder 206). When decoder 206 generates autoregressive distributions, teacher forcing can be used to feed both input 404 and latent representation 406 into decoder 206:

$${h}_{i} = Decoder ( {x}_{i} \vert {z}_{i} ∼ {q}_{θ} ( z \vert {x}_{i} ) ) = Decoder ( {x}_{i} , Encoder ( {x}_{i} ) ) \qquad ( 11 )$$

Given this input 404 and latent representation 406, decoder 206 may execute multiple sets of self-attention mechanisms in parallel to generate all rows of hidden outputs instead of iteratively generating individual rows of hidden outputs based on previously sampled output tokens. Each set of self-attention mechanisms is used to generate a different row of hidden outputs (and output token) and allows all vectors within decoder 206 that correspond to latent representation 406 and positions that precede the position associated with the row of hidden outputs to attend to one another.

Thus, input 404 that includes an N×D matrix representing the entire example data sample 402 of “CCCCNC(=O)COc1cc(C(C)C)ccc1C” may be inputted along with latent representation 406 into decoder 206. Each row in input 404 may include an encoded vector representation of a corresponding input token. A row of hidden states for the first token outputted by decoder 206 (e.g., the last “C” at the end of decoder output 408) may be computed using a first set of self-attention mechanisms that attends to latent representation 406 and an encoded vector representation of a “beginning of string” token. A row of hidden states for the second token outputted by decoder 206 (e.g., the “1” preceding the last “C” at the end of decoder output 408) may be computed using a second set of self-attention mechanisms that attends to latent representation 406, an encoded vector representation of the “beginning of string” token, and an encoded vector representation of the last “C” in data sample 402. The process may be repeated in a similar manner for all other tokens, with a row of hidden states for the last token outputted by decoder 206 (e.g., the first “C” in decoder output 408) computed using a set of self-attention mechanisms that attends to latent representation 406 and encoded vector representations of all preceding tokens in data sample 402.

When hidden outputs are variable-sized (i.e., when the value of N can vary), the hidden outputs can be aggregated into a fixed-size representation that corresponds to informative embeddings 222. For example, N rows of hidden outputs that have the same length D and are associated with different output tokens in a variable-sized text output may be averaged to produce a fixed-size vector of length D that corresponds to informative embeddings 222 for data sample 402.

While the operation of encoder 204 and decoder 206 has been described above with respect to certain types of losses and/or neural network architectures, it will be appreciated that informative embeddings 222 can be generated using other types of encoder-decoder machine learning models. For example, informative embeddings 222 may be generated using a VAE, MIM model, denoising auto-encoder, and/or another type of latent variable model that includes an encoder and a decoder. Informative embeddings 222 may also, or instead, be generated using an encoder and decoder that have been trained using various types of losses to learn “meaningful” latent representations of input data samples.

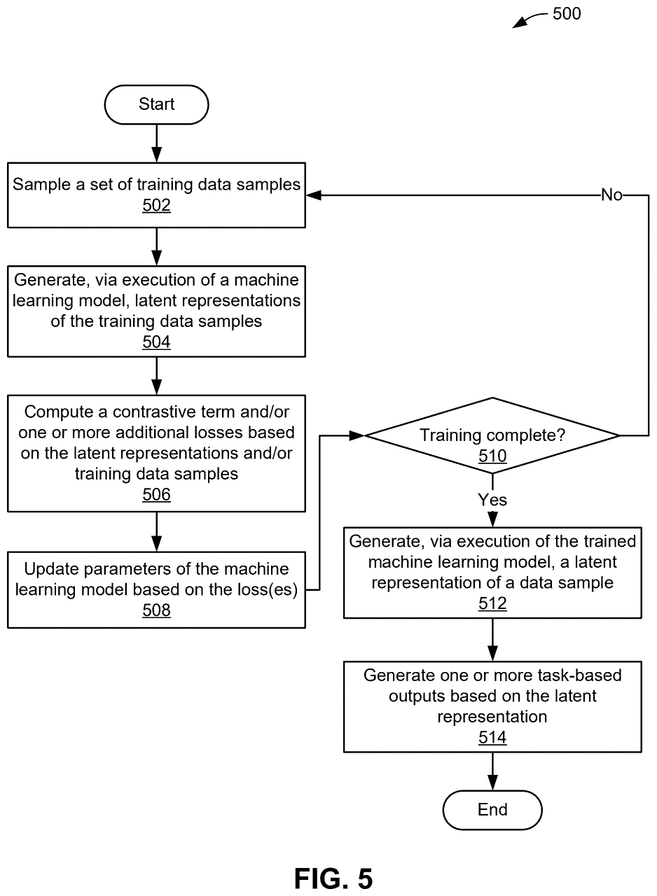

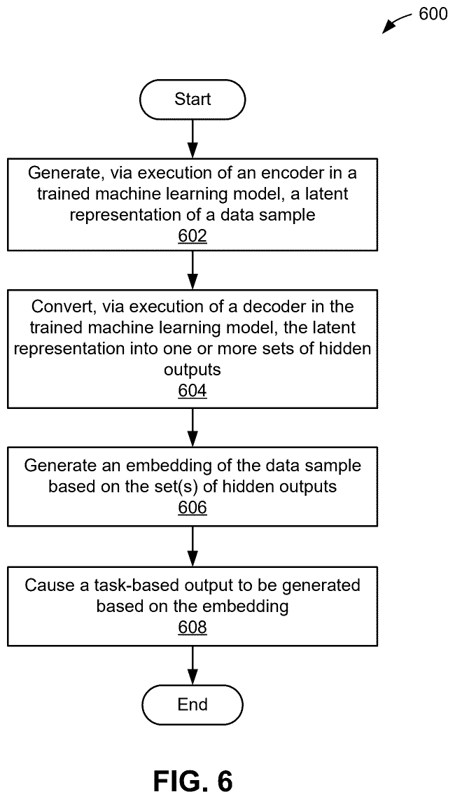

Now referring to FIGS. 5-6, each block of methods 500 and 600 described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 500 and 600 are described, by simulated way of example, with respect to the systems of FIGS. 1-2. However, these methods may additionally or alternatively be executed by any one system, or any combination of systems, including, but not limited to, those described herein. Further, the operations in methods 500 and 600 may be omitted, repeated, and/or performed in any order without departing from the scope of the present disclosure.

FIG. 5 illustrates a flow diagram of a method 500 for performing generative and discriminative representation learning, according to at least one embodiment. As shown in FIG. 5, method 500 begins with operation 502, in which training engine 122 samples a set of training data samples. For example, training engine 122 may sample images, text, molecules, audio, video, and/or other types of training data samples from a training dataset.

In operation 504, training engine 122 generates, via execution of a machine learning model, latent representations of the training data samples. For example, training engine 122 may use an encoder in the machine learning model to convert each training data sampled in operation 502 into a corresponding latent representation in a lower-dimensional vector space.

In operation 506, training engine 122 computes a contrastive term and/or one or more additional losses based on the latent representations and/or training data samples. For example, training engine 122 may compute the contrastive term as a Bernoulli distribution that is parameterized using an expression that includes an aggregation of similarity measures (e.g., cosine similarities) between a given latent representation of a training data sample sampled in operation 502 and additional latent representations of additional training data samples sampled in operation 502. Training engine 122 may also, or instead, compute a reconstruction loss associated with the plurality of training data samples, a consistency loss associated with a joint distribution over the training data samples and the latent representations, and/or a regularization loss associated with the latent representations.

In operation 508, training engine 122 updates parameters of the machine learning model based on the loss(es). For example, training engine 122 may use gradient descent and backpropagation and/or another type of training and/or optimization technique to update the parameters of the machine learning model in a way that reduces the loss(es).

In operation 510, training engine 122 determines whether training of the machine learning model is complete. For example, training engine 122 may determine that training is complete when one or more conditions are met. These condition(s) include (but are not limited to) convergence in the parameters of the machine learning model, the lowering of the loss(es) to below one or more corresponding thresholds, and/or a certain number of training steps, iterations, batches, and/or epochs. While training of the machine model is not complete, training engine 122 repeats one or more iterations of operations 502, 504, 506, 508, and 510. Training engine 122 then ends the process of training the machine model once training engine 122 determines in operation 510 that the condition(s) are met.

In operation 512, execution engine 124 generates, via execution of the trained machine learning model, a latent representation of a data sample. For example, execution engine 124 may use the encoder in the trained machine learning model to convert the data sample into the latent representation. Execution engine 124 may also, or instead, use the encoder and a decoder in the trained machine learning model to convert the data sample into an “informative” embedding, as described in further detail below with respect to FIG. 6.

In operation 514, execution engine 124 generates one or more task-based outputs based on the latent representation. For example, execution engine 124 may input the latent representation into one or more additional machine learning models. Execution engine 124 may obtain, as corresponding output of the additional machine learning model(s), a class associated with the data sample, an attribute associated with the data sample, and/or a score representing a probability, an extent to which an attribute exists in the data sample, and/or another measure associated with the data sample. In another example, execution engine 124 may perform clustering, similarity analysis, anomaly detection, and/or other types of unsupervised learning using the latent representation. In a third example, execution engine 124 may use the latent representation to reconstruct the data sample and/or generate a new data sample. Because the latent representation resides in a latent space that includes a global discriminative structure and local clustering, the latent representation may be used in both generative and discriminative downstream tasks.

FIG. 6 illustrates a flow diagram of a method 600 for generating an embedding of a data sample, according to at least one embodiment. As shown in FIG. 6, method 600 begins with operation 602, in which execution engine 124 generates, via execution of an encoder in a trained machine learning model, a latent representation of a data sample. For example, execution engine 124 may use an encoder that is implemented using a perceiver neural network, transformer neural network, and/or another type of architecture that is used in a latent variable model (e.g., VAE, MIM) to convert the data sample into the latent representation.

In operation 604, execution engine 124 converts, via execution of a decoder in the trained machine learning model, the latent representation into one or more sets of hidden outputs. For example, execution engine 124 may input the latent representation into the decoder. Execution engine 124 may process the latent representation using one or more hidden layers of the decoder (e.g., a hidden layer that immediately precedes a mapping to an output distribution) to generate the hidden outputs. When the trained machine learning model includes a transformer neural network and/or another type of neural network that generates autoregressive distributions, execution engine 124 may use teacher forcing to input the data sample along with the latent representation into the decoder. Execution engine 124 may then execute different sets of attention mechanisms that attend to different subsets of positions within the data sample in parallel to generate multiple sets of hidden outputs corresponding to the positions.

In operation 606, execution engine 124 generates an embedding of the data sample based on the set(s) of hidden outputs. For example, execution engine 124 may use a single set of hidden outputs produced by the decoder from the latent representation as the embedding. When multiple sets of hidden outputs are generated by the decoder (e.g., based on a variable-sized sequence in data sample and/or the output of the decoder), execution engine 124 may generate a fixed-size embedding as an average and/or another aggregation of the sets of hidden outputs.

In operation 608, execution engine 124 causes a task-based output to be generated based on the embedding. For example, execution engine 124 may input the embedding and/or latent representation into another machine learning model. Execution engine 124 may also use the other machine learning model to determine, based on the inputted embedding and/or latent representation, a class associated with the data sample, an attribute associated with the data sample, a score associated with the data sample, a reconstruction of the data sample, and/or a new data sample (e.g., using a second embedding that is derived from the inputted embedding). In another example, execution engine 124 may use the latent representation and latent representations of other data samples to generate and/or determine clusters, measures of similarity, dimensionality reductions, anomalies, and/or other types of unsupervised task-based outputs.

In sum, the disclosed techniques extend a Mutual Information Machine (MIM) model and/or another type of latent variable model using a contrastive learning component that distinguishes between each data sample and all other data samples from the same distribution. The contrastive learning component includes a random variable that represents the relationship between a data sample and a latent representation. The random variable is set to 1 when the latent representation corresponds to the data sample and to 0 otherwise. The contrastive learning component also uses Markov Chain Monte Carlo (MCMC) sampling to approximate the expected similarity between a given data sample and other data samples in the distribution, which decouples the similarity estimation associated with contrastive learning from the batch size used to train the latent variable model. The additional random variable is incorporated into encoding and decoding factorizations of a joint distribution over data and latent representations that are learned by the encoder and decoder of the latent variable model, respectively. The discriminator distributions for the encoding and decoding factorizations are defined as Bernoulli distributions. Each Bernoulli distribution includes a parameter that approximates the probability that the random variable is set to 1 using a similarity measure that is computed between pairs of latent representations.

During training of the latent variable model, parameters of the latent variable model are updated in a way that reduces a combination of a MIM loss (or another type of loss associated with the latent variable model) and a contrastive term corresponding to the contrastive learning component. The MIM loss clusters latent representations of similar data samples, and the contrastive term encourages dissimilar data samples to be farther apart from one another with respect to an origin in the latent space.

The disclosed techniques also generate informative embeddings from a MIM model and/or another type of encoder-decoder model that learns a distribution over a set of outputs. An encoder in the encoder-decoder model is used to convert a given data sample into a latent representation, and the latent representation is inputted into a decoder in the encoder-decoder model. The informative embeddings are extracted as hidden outputs from one or more hidden layers of the decoder (e.g., before the hidden outputs are converted into parameters of the decoded output distribution) and can be used for various downstream tasks. When the encoder-decoder model generates autoregressive distributions, teacher forcing can be used to input both the data sample and the latent representation into the decoder. The decoder then generates, in parallel, multiple sets of hidden outputs from the inputted data sample and latent representation, where each set of hidden outputs corresponds to a different position in a sequence associated the data sample and is conditioned on preceding positions within the sequence. The multiple sets of hidden outputs can then be averaged or otherwise aggregated into a fixed-size representation.

One advantage of the disclosed techniques relative to prior approaches is the ability to generate informative representations of data that are effective for various downstream tasks, including (but not limited to) generative downstream tasks and discriminative downstream tasks. Consequently, the disclosed techniques may improve the performance of the downstream tasks relative to MIM models (or other type of latent variable and/or encoder-decoder models) that do not optimize for unique identification of individual latent representations within a latent space. Another advantage of the disclosed techniques is the ability to incorporate contrastive learning into a latent variable model without performing data augmentation and/or selecting negative data samples from within the same batch. An additional advantage of the disclosed techniques is the decoupling of batch sizes from the computation of a contrastive loss that is used to train a latent variable model and/or encoder-decoder model. The disclosed techniques may thus simplify training of the latent variable model and/or reduce inductive bias over conventional contrastive learning techniques that use augmented data and/or batches of positive and negative data samples to train machine learning models.

### Inference and Training Logic

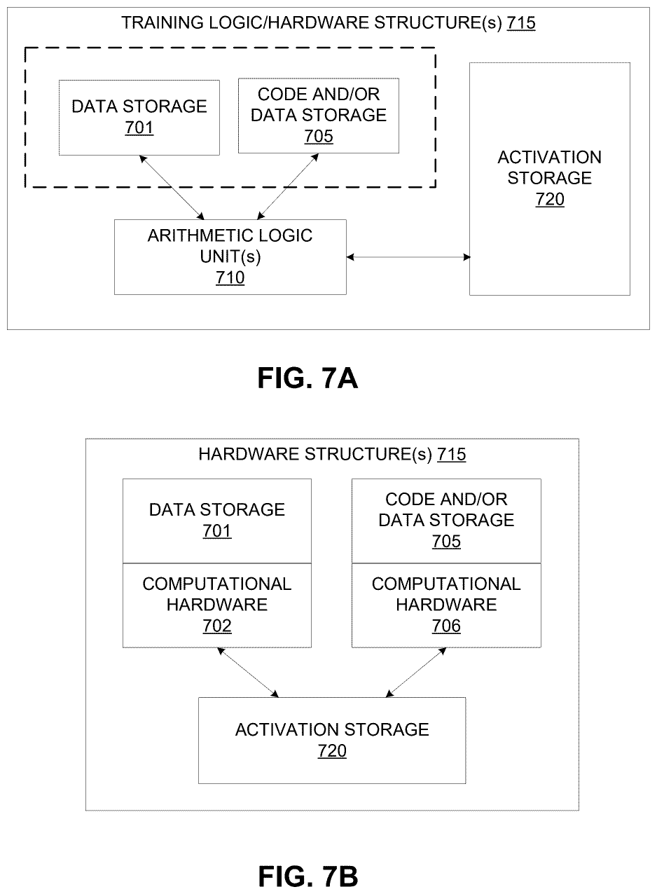

FIG. 7A illustrates inference and/or training logic 715 used to perform inferencing and/or training operations associated with one or more embodiments. Details regarding inference and/or training logic 715 are provided herein in conjunction with at least FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

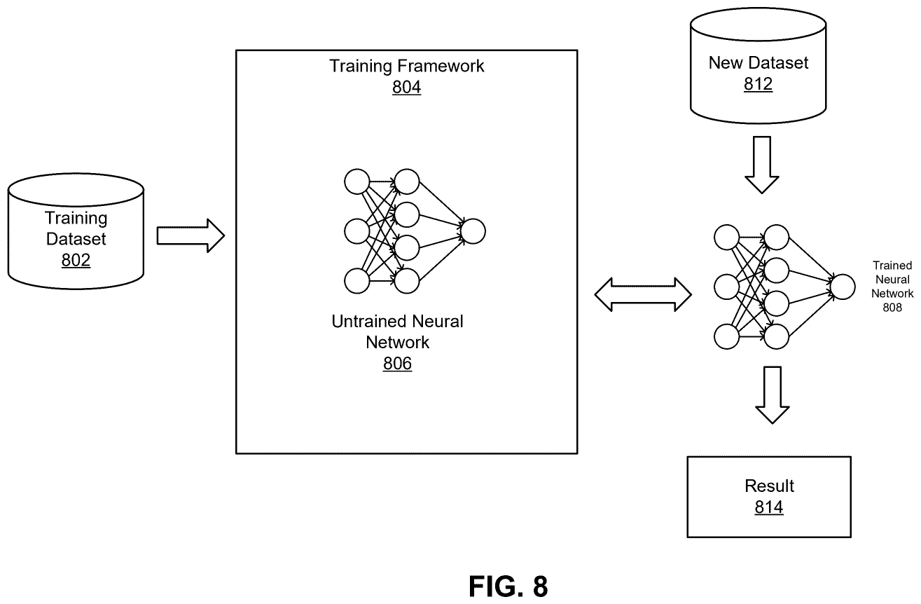

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

In at least one embodiment, training framework 804 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based neural networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, OpenVINO provides various software functions to execute a program and/or portions of a program on different devices. In at least one embodiment, OpenVINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In the present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.
1. In some embodiments, a method comprises converting, via execution of a machine learning model, a plurality of training data samples into a first plurality of latent representations; computing one or more losses based on the first plurality of latent representations, wherein the one or more losses comprise a contrastive term that approximates an expected similarity between a latent representation of a training data sample included in the plurality of training data samples and a second plurality of latent representations associated with a distribution of training data samples that includes the plurality of training data samples; and updating one or more parameters of the machine learning model based on the one or more losses to generate a trained machine learning model.
2. The method of clause 1, further comprising generating, via execution of the trained machine learning model, an additional latent representation of an additional data sample; and generating one or more task-based outputs based on the additional latent representation.
3. The method of any of clauses 1-2, wherein the one or more task-based outputs comprise at least one of a class associated with the additional data sample, an attribute associated with the additional data sample, or a score associated with the additional data sample.
4. The method of any of clauses 1-3, wherein computing the one or more losses comprises computing the contrastive term based on an aggregation of a plurality of similarity measures between the latent representation and the first plurality of latent representations.
5. The method of any of clauses 1-4, wherein computing the one or more losses further comprises parameterizing a second distribution based on the aggregation of the plurality of similarity measures.
6. The method of any of clauses 1-5, wherein the aggregation comprises an average.
7. The method of any of clauses 1-6, wherein the one or more parameters are updated to minimize an upper bound corresponding to the one or more losses.
8. The method of any of clauses 1-7, wherein the one or more losses further comprise at least one of a reconstruction loss associated with the plurality of training data samples, a consistency loss associated with a joint distribution over the plurality of training data samples and the first plurality of latent representations, or a regularization loss associated with the first plurality of latent representations.
9. The method of any of clauses 1-8, wherein the plurality of training data samples comprises at least one of an image, a representation of a molecule, or text.
10. The method of any of clauses 1-9, wherein the machine learning model comprises an encoder and a decoder.
11. In some embodiments, at least one processor comprises processing circuitry to perform operations comprising converting, via execution of a machine learning model, a plurality of training data samples into a first plurality of latent representations; computing one or more losses based on the first plurality of latent representations, wherein the one or more losses comprise a contrastive term that approximates an expected similarity between a latent representation of a training data sample included in the plurality of training data samples and a second plurality of latent representations associated with a distribution of training data samples that includes the plurality of training data samples; and updating one or more parameters of the machine learning model based on the one or more losses to generate a trained machine learning model.
12. The at least one processor of clause 11, wherein the operations further comprise generating, via execution of an encoder included in the trained machine learning model, a first latent representation of a data sample; converting the first latent representation into a second latent representation; and generating, via execution of a decoder included in the trained machine learning model, a new data sample based at least on the second latent representation.
13. The at least one processor of any of clauses 11-12, wherein converting the first latent representation into the second latent representation comprises at least one of perturbing the first latent representation or interpolating between the first latent representation and a third latent representation.
14. The at least one processor of any of clauses 11-13, wherein the new data sample comprises at least one of an image, a representation of a molecule, or text.
15. The at least one processor of any of clauses 1-114, wherein computing the one or more losses comprises sampling a subset of the plurality of training data samples; and computing the contrastive term based on an aggregation of a plurality of similarity measures between the latent representation and the second plurality of latent representations of the subset of the plurality of training data samples.
16. The at least one processor of any of clauses 11-15, wherein computing the one or more losses further comprises defining a Bernoulli distribution based on the aggregation of the plurality of similarity measures.
17. The at least one processor of any of clauses 11-16, wherein the plurality of similarity measures comprises a cosine similarity.
18. The at least one processor of any of clauses 11-17, wherein the at least one processor is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implemented using one or more small language models (SLMs); a system implementing one or more vision language models (VLMs); a system implementing one or more multi modal language models; a system for generating synthetic data; a system for performing one or more generative AI operations; a system incorporating one or more virtual machines (VMs); a system implemented at least partially in a data center; or a system implemented at least partially using cloud computing resources.
19. In some embodiments, a system comprises one or more processors to perform operations comprising converting, via execution of a machine learning model, a plurality of training data samples into a plurality of latent representations; computing one or more losses based on the plurality of latent representations, wherein the one or more losses comprise a contrastive term that includes an aggregation of a plurality of similarity measures between a latent representation included in the plurality of latent representations and one or more additional latent representations included in the plurality of latent representations; and updating one or more parameters of the machine learning model based on the one or more losses to generate a trained machine learning model.
20. The system of clause 19, wherein the system is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implemented using one or more small language models (SLMs); a system implementing one or more vision language models (VLMs); a system implementing one or more multi modal language models; a system for generating synthetic data; a system for performing one or more generative AI operations; a system incorporating one or more virtual machines (VMs); a system implemented at least partially in a data center; or a system implemented at least partially using cloud computing resources.
21. In some embodiments, a method comprises generating, via execution of an encoder included in a trained machine learning model, a latent representation of a data sample; converting, via execution of one or more hidden layers within a decoder included in the trained machine learning model, the latent representation into one or more sets of hidden outputs; generating an embedding of the data sample based on at least a portion of the one or more sets of hidden outputs; and causing a task-based output to be generated based on the embedding of the data sample.
22. The method of clause 21, further comprising computing one or more losses based on a plurality of latent representations generated by a machine learning model from a plurality of training data samples, wherein the one or more losses comprise a contrastive term that approximates an expected similarity between an additional latent representation of a training data sample included in the plurality of training data samples and a second plurality of latent representations associated with a distribution of training data samples that includes the plurality of training data samples; and updating one or more parameters of the machine learning model based on the one or more losses to generate the trained machine learning model.
23. The method of any of clauses 21-22, wherein the plurality of training data samples comprises at least one of an image, a representation of a molecule, or text.
24. The method of any of clauses 21-23, wherein converting the latent representation into the one or more sets of hidden outputs comprises inputting the latent representation and the data sample into the decoder; and generating, via execution of a first set of self-attention mechanisms included in the decoder based on the inputted latent representation and a first portion of the inputted data sample, a first set of hidden outputs included in the one or more sets of hidden outputs.
25. The method of any of clauses 21-24, wherein converting the latent representation into the one or more sets of hidden outputs further comprises generating, via execution of a second set of self-attention mechanisms included in the decoder based on the inputted latent representation and a second portion of the inputted data sample, a second set of hidden outputs included in the one or more sets of hidden outputs.
26. The method of any of clauses 21-25, wherein generating the embedding of the data sample comprises computing an average of the first set of hidden outputs and the second set of hidden outputs.
27. The method of any of clauses 21-26, wherein the first portion of the data sample comprises a first sequence of tokens included in the data sample and the second portion of the data sample comprises the first sequence of tokens and one or more additional tokens included in the data sample.
28. The method of any of clauses 21-27, wherein the one or more hidden layers immediately precede a mapping to a set of parameters of a decoding distribution associated with the decoder.
29. The method of any of clauses 21-28, wherein the task-based output comprises at least one of a class associated with the data sample, an attribute associated with the data sample, a score associated with the data sample, a reconstruction of the data sample, or a generation of a new data sample.
30. The method of any of clauses 21-29, wherein the encoder comprises a perceiver neural network and the decoder comprises a transformer neural network.
31. In some embodiments, at least one processor comprising processing circuitry to perform operations comprising generating, via execution of an encoder included in a trained machine learning model, a latent representation of a data sample; converting, via execution of one or more hidden layers within a decoder included in the trained machine learning model, the latent representation into one or more sets of hidden outputs; generating an embedding of the data sample based on at least a portion of the one or more sets of hidden outputs; and causing a task-based output to be generated based on the embedding of the data sample.
32. The at least one processor of clause 31, wherein the operations further comprise computing one or more losses based on a plurality of latent representations generated by a machine learning model from a plurality of training data samples, wherein the one or more losses comprise an aggregation of a plurality of similarity measures between an additional latent representation of a training data sample included in the plurality of training data samples and one or more additional latent representations included in the plurality of latent representations; and updating one or more parameters of the machine learning model based on the one or more losses to generate the trained machine learning model.
33. The at least one processor of any of clauses 31-32, wherein computing the one or more losses comprises sampling the plurality of training data samples from a training dataset associated with the machine learning model; and computing the one or more losses based on a distribution that is parameterized using the aggregation of the plurality of similarity measures.
34. The at least one processor of any of clauses 31-33, wherein converting the latent representation into the one or more sets of hidden outputs comprises inputting the latent representation and the data sample into the decoder; and generating, via execution of one or more sets of self-attention mechanisms included in the decoder based on the inputted latent representation and the data sample, the one or more sets of hidden outputs corresponding to one or more output distributions associated with the data sample.
35. The at least one processor of any of clauses 31-34, wherein generating the embedding of the data sample comprises aggregating the one or more sets of hidden outputs into the embedding.
36. The at least one processor of any of clauses 31-35, wherein the one or more sets of hidden outputs are generated prior to a mapping to a set of parameters of a decoding distribution associated with the decoder.
37. The at least one processor of any of clauses 31-36, wherein causing the task-based output to be generated comprises at least one of generating a class associated with the data sample based on the embedding; determining an attribute associated with the data sample based on the embedding; computing a score associated with the data sample based on the embedding; generating a reconstruction of the data sample based on the embedding; or generating a new data sample based on a second embedding that is derived from the embedding.
38. The at least one processor of any of clauses 31-37, wherein the at least one processor is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implemented using one or more small language models (SLMs); a system implementing one or more vision language models (VLMs); a system implementing one or more multi modal language models; a system for generating synthetic data; a system for performing one or more generative AI operations; a system incorporating one or more virtual machines (VMs); a system implemented at least partially in a data center; or a system implemented at least partially using cloud computing resources.
39. In some embodiments, a system comprises one or more processors to perform operations comprising generating, via execution of an encoder included in a trained machine learning model, a latent representation of a data sample; converting, via execution of one or more hidden layers within a decoder included in the trained machine learning model, the latent representation into one or more sets of hidden outputs; generating an embedding of the data sample based on at least a portion of the one or more sets of hidden outputs; and causing a task-based output to be performed based on the embedding of the data sample.
40. The system of clause 39, wherein the system is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implemented using one or more small language models (SLMs); a system implementing one or more vision language models (VLMs); a system implementing one or more multi modal language models; a system for generating synthetic data; a system for performing one or more generative AI operations; a system incorporating one or more virtual machines (VMs); a system implemented at least partially in a data center; or a system implemented at least partially using cloud computing resources.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
converting, via execution of a machine learning model, a plurality of training data samples into a first plurality of latent representations;
computing one or more losses based on the first plurality of latent representations, wherein the one or more losses comprise a contrastive term that approximates an expected similarity between a latent representation of a training data sample included in the plurality of training data samples and a second plurality of latent representations associated with a distribution of training data samples that includes the plurality of training data samples; and
updating one or more parameters of the machine learning model based on the one or more losses to generate a trained machine learning model.

2. The method of claim 1, further comprising:
generating, via execution of the trained machine learning model, an additional latent representation of an additional data sample; and
generating one or more task-based outputs based on the additional latent representation.

3. The method of claim 2, wherein the one or more task-based outputs comprise at least one of a class associated with the additional data sample, an attribute associated with the additional data sample, or a score associated with the additional data sample.

4. The method of claim 1, wherein computing the one or more losses comprises computing the contrastive term based on an aggregation of a plurality of similarity measures between the latent representation and the first plurality of latent representations.

5. The method of claim 4, wherein computing the one or more losses further comprises parameterizing a second distribution based on the aggregation of the plurality of similarity measures.

6. The method of claim 4, wherein the aggregation comprises an average.

7. The method of claim 1, wherein the one or more parameters are updated to minimize an upper bound corresponding to the one or more losses.

8. The method of claim 1, wherein the one or more losses further comprise at least one of a reconstruction loss associated with the plurality of training data samples, a consistency loss associated with a joint distribution over the plurality of training data samples and the first plurality of latent representations, or a regularization loss associated with the first plurality of latent representations.

9. The method of claim 1, wherein the plurality of training data samples comprises at least one of an image, a representation of a molecule, or text.

10. The method of claim 1, wherein the machine learning model comprises an encoder and a decoder.

11. At least one processor comprising:
processing circuitry to perform operations comprising:
converting, via execution of a machine learning model, a plurality of training data samples into a first plurality of latent representations;
computing one or more losses based on the first plurality of latent representations, wherein the one or more losses comprise a contrastive term that approximates an expected similarity between a latent representation of a training data sample included in the plurality of training data samples and a second plurality of latent representations associated with a distribution of training data samples that includes the plurality of training data samples; and
updating one or more parameters of the machine learning model based on the one or more losses to generate a trained machine learning model.

12. The at least one processor of claim 11, wherein the operations further comprise:
generating, via execution of an encoder included in the trained machine learning model, a first latent representation of a data sample;
converting the first latent representation into a second latent representation; and
generating, via execution of a decoder included in the trained machine learning model, a new data sample based at least on the second latent representation.

13. The at least one processor of claim 12, wherein converting the first latent representation into the second latent representation comprises at least one of perturbing the first latent representation or interpolating between the first latent representation and a third latent representation.

14. The at least one processor of claim 12, wherein the new data sample comprises at least one of an image, a representation of a molecule, or text.

15. The at least one processor of claim 11, wherein computing the one or more losses comprises:
sampling a subset of the plurality of training data samples; and
computing the contrastive term based on an aggregation of a plurality of similarity measures between the latent representation and the second plurality of latent representations of the subset of the plurality of training data samples.

16. The at least one processor of claim 15, wherein computing the one or more losses further comprises defining a Bernoulli distribution based on the aggregation of the plurality of similarity measures.

17. The at least one processor of claim 15, wherein the plurality of similarity measures comprises a cosine similarity.

18. The at least one processor of claim 11, wherein the at least one processor is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implemented using one or more small language models (SLMs);
a system implementing one or more vision language models (VLMs);
a system implementing one or more multi modal language models;
a system for generating synthetic data;
a system for performing one or more generative AI operations;
a system incorporating one or more virtual machines (VMs);
a system implemented at least partially in a data center; or
a system implemented at least partially using cloud computing resources.

19. A system comprising:
one or more processors to perform operations comprising:
converting, via execution of a machine learning model, a plurality of training data samples into a plurality of latent representations;
computing one or more losses based on the plurality of latent representations, wherein the one or more losses comprise a contrastive term that includes an aggregation of a plurality of similarity measures between a latent representation included in the plurality of latent representations and one or more additional latent representations included in the plurality of latent representations; and
updating one or more parameters of the machine learning model based on the one or more losses to generate a trained machine learning model.

20. The system of claim 19, wherein the system is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implemented using one or more small language models (SLMs);
a system implementing one or more vision language models (VLMs);
a system implementing one or more multi modal language models;
a system for generating synthetic data;
a system for performing one or more generative AI operations;
a system incorporating one or more virtual machines (VMs);
a system implemented at least partially in a data center; or
a system implemented at least partially using cloud computing resources.
